(19) United States
(12) Patent Application Publication
(10) Pub. No.: US 2009/0240710 A1
(43) Pub. Date: Sep. 24, 2009

(54) METHOD AND SYSTEM FOR CREATING A REDUCED MEDIA FILE FOR USE ON A MOBILE DEVICE

(75) Inventors: Joseph M. Bilman, Brooklyn, NY (US); Paula Buzzard, Brooklyn, NY (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: Thumbplay, Inc., New York, NY (US)

(21) Appl. No.: 12/051,781

(22) Filed: Mar. 19, 2008

(51) Int. Cl. G06F 17/30

(52) U.S. Cl. 707/100; 707/E17.005

(57) ABSTRACT

The invention provides a computer-based method of manipulating electronic media, including transmitting an initial media file to a publishing user computer system, the initial media file having media content playing from a start time to an end time over a first duration of time, transmitting an editing tool to the publishing user computer system, the editing tool being usable at the publishing user computer system to make at least one time selection after the start time and before the end time of the initial media file, receiving a publish command from the publishing user computer system at a server computer system, and storing a reduced media file at the server computer system in response to the publish command, the reduced media file having media content from the initial media file, playing over a second duration of time that is shorter than the first duration of time, and having at least one of a start time and an end time that depends on the time selection made using the editing tool at the publishing user computer system.

### BACKGROUND OF THE INVENTION

1). Field of the Invention

This invention relates to a computer-based method and system for manipulating electronic media such as ringtones and videos.

2). Discussion of Related Art

Mobile phones usually have a number of ringtones that are installed by a manufacturer. A user can select a ringtone from a drop-down list, and it is also sometimes possible to associate different ringtones with different incoming phone numbers.

A user may wish to download a ringtone from a remote server and store the ringtone in memory of the mobile phone. However, a mobile phone and the network that it is connected to are usually too slow and the viewing capabilities on the mobile phone are too limited for finding media on a remote server. A company that provides mobile media content for use on mobile phones will usually also have a website that is accessible from a user computer system over the internet. The user of the mobile phone may make use of the user computer system to find listings of mobile content on the website through browsing or searching functionality built into the website, and then instruct the website to facilitate downloading of the media content to the mobile phone. A message may, for example, be sent to the mobile phone, and the message can include a link to the media content on the server.

### SUMMARY OF THE INVENTION

The invention provides a computer-based method of manipulating electronic media, including transmitting an initial media file to a publishing user computer system, the initial media file having media content playing from a start time to an end time over a first duration of time, transmitting an editing tool to the publishing user computer system, the editing tool being usable at the publishing user computer system to make at least one time selection after the start time and before the end time of the initial media file, receiving a publish command from the publishing user computer system at a server computer system, and storing a reduced media file at the server computer system in response to the publish command, the reduced media file having media content from the initial media file, playing over a second duration of time that is shorter than the first duration of time, and having at least one of a start time and an end time that depends on the time selection made using the editing tool at the publishing user computer system.

The method further includes receiving at least one reduction command from the publishing user computer system at the server computer system, the reduction command including the time selection and the reduced media file being extracted from the initial media file at the server computer system in response to the server computer system receiving the reduction command and utilizing the time selection.

The time selection may be a start time selection, the editing tool further being usable to make an end time selection after the start time selection and before the end time of the initial media file, the reduced media file having a start time depending on the start time selection and an end time depending on the end time selection.

The second duration may have a maximum duration that is limited other than by the starting time and the end time of the initial media file.

The second duration may be less than the maximum duration.

Adjustment of one of the time selections may automatically adjust the other time selection.

Adjustment of one of the time selections may automatically adjust the other time selection when the second duration is less than the maximum duration.

The editing tool may create a sound output of the media content of the initial media file.

The editing tool may create a visual representation on a display of the publishing user computer system, the visual representation including time for purposes of making the time selection.

The method may further include transmitting at least one naming field to the publishing user computer system, a name being entered in the naming field at the publishing user computer system being saved and related to the reduced media file at the server computer system.

The method may further include publishing a link to the reduced media file on a web page, receiving a download selection command from an acquiring user computer system upon selection of the link, and in response to the download selection command, transmitting the reduced media file from the server computer system.

The reduced media file may be transmitted to an acquiring user mobile phone.

The invention also provides a computer-readable medium, having stored thereon a set of instructions that, when executed by a processor of a computer, carries out a computer-based method of manipulating electronic media, including transmitting an initial media file to a publishing user computer system, the initial media file having media content playing from a start time to an end time over a first duration of time, transmitting an editing tool to the publishing user computer system, the editing tool being usable at the publishing user computer system to make at least one time selection after the start time and before the end time of the initial media file, receiving a publish command from the publishing user computer system at a server computer system, and storing a reduced media file at the server computer system in response to the publish command, the reduced media file having media content from the initial media file, playing over a second duration of time that is shorter than the first duration of time, and having at least one of a start time and an end time that depends on the time selection made using the editing tool at the publishing user computer system.

The invention further provides a server computer system for manipulating electronic media, including at least one file database from which an initial media file is transmitted to a publishing user computer system, the initial media file having media content playing from a start time to an end time over a first duration of time, an editing tool that is transmitted to the publishing user computer system, the editing tool being usable at the publishing user computer system to make at least one time selection after the start time and before the end time of the initial media file, a publishing component receiving a publish command from the publisher user computer system and storing a reduced media file in response to the publish command, the reduced media file having media content from the initial media file, playing over a second duration of time that is shorter than the first duration of time, and having at least one of a start time and an end time that depends on the time selection made using the editing tool at the publishing user computer system.

### BRIEF DESCRIPTION OF THE DRAWINGS

The invention is further described by way of example with reference to the accompanying drawings, wherein:

FIG. 1 illustrates part of a network system embodying principles of the invention;

FIG. 2 is a flow chart illustrating how the system of FIG. 1 is used to create and store a reduce media file;

FIG. 3 shows a browser view displaying a publisher-specific page for a publisher user;

FIG. 4 is a block diagram showing components that reside on a publisher user computer system;

FIG. 5 shows the browser view displaying a view that includes an editing window for creating a reduced media file from an initial media file;

FIG. 6 is a view similar to FIG. 5, after a start selection marker is moved to the right;

FIG. 7 is a view similar to FIG. 6, after an area between start and end selector markers is moved to the left;

FIG. 8 is a view similar to FIG. 7, after the end selection marker is moved to the right;

FIG. 9 shows the browser view displaying a view with a reduced media file title field;

FIG. 10 is a block diagram illustrating further components of the network system of FIG. 1;

FIG. 11 shows a browser view that displays a view in a general area of a website of FIG. 10;

FIG. 12 shows the browser view displaying a view with ringtone search results;

FIG. 13 shows the browser view displaying a view that appears upon selection of a “download” button in FIG. 12, and includes profile data for transmission of a ringtone to a mobile device; and

FIG. 14 is a block diagram of a machine in the form of a computer that can find application in the present invention system, in accordance with one embodiment of the invention.

### DETAILED DESCRIPTION OF THE INVENTION

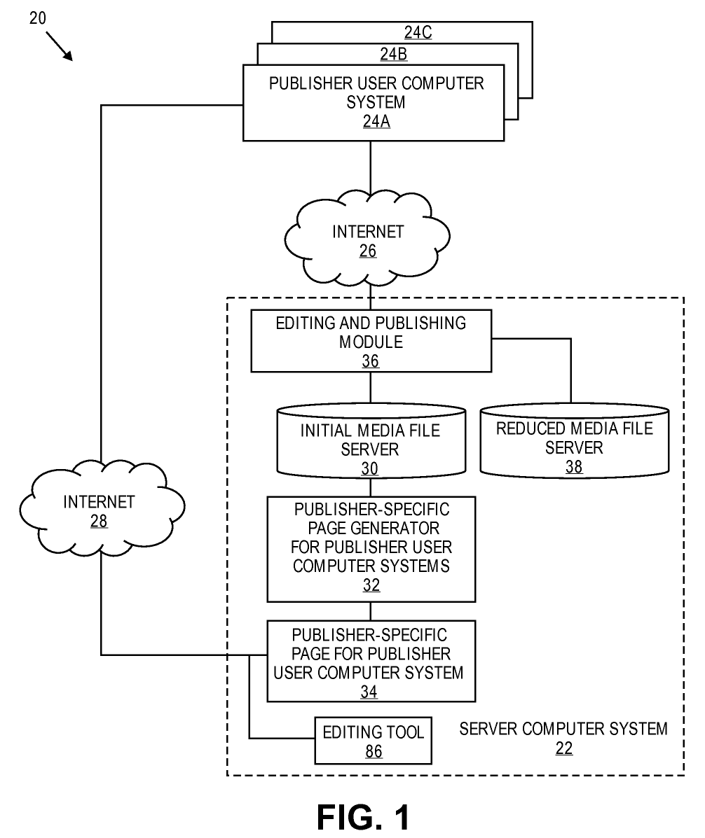

FIG. 1 of the accompanying drawings illustrates part of a network system 20, according to an embodiment of the invention, including a server computer system 22, a plurality of publisher user computer systems 24A, 24B, and 24C, and a network in the form of the internet 26 and 28. The internet 26 and 28 is shown as separate components to illustrate how components of the server computer system 22 connect to the publisher user computers systems 24A, B, and C, although it should be understood that the internet 26 and 28 is a single network.

The server computer system 22 includes an initial media file server 30, a publisher-specific page generator 32 for each one of the publisher user computer systems 24A, 24B, and 24C, a publisher-specific page 34 for each one of the publisher user computer systems 24A, 24B, and 24C, an editing and publishing module 36, and reduced media file server 38. The publisher-specific page generator 32 is connected to the initial media file server 30. Each one of the publisher-specific pages 34 is connected to the publisher-specific page generator 32. The editing and publishing module 36 is connected to the initial media file server 30 and to the reduced media file server 38.

Each one of the publisher user computer systems 24A, B, and C is connected over the internet 28 to a respective publisher-specific page 34. Each one of the publisher user computer systems 24A is also connected over the internet 26 to the editing and publishing module 36. For purposes of further discussion, only a single one of the publisher user computer systems 24A and its interaction with the server computer system 22 is described. It should, however, be understood that each one of the publisher user computer systems 24A, 24B, and 24C has its own respective publisher-specific page 34 associated therewith, and can function to create reduced media files in a manner similar to the manner that is described with respect to the publisher user computer system 24A.

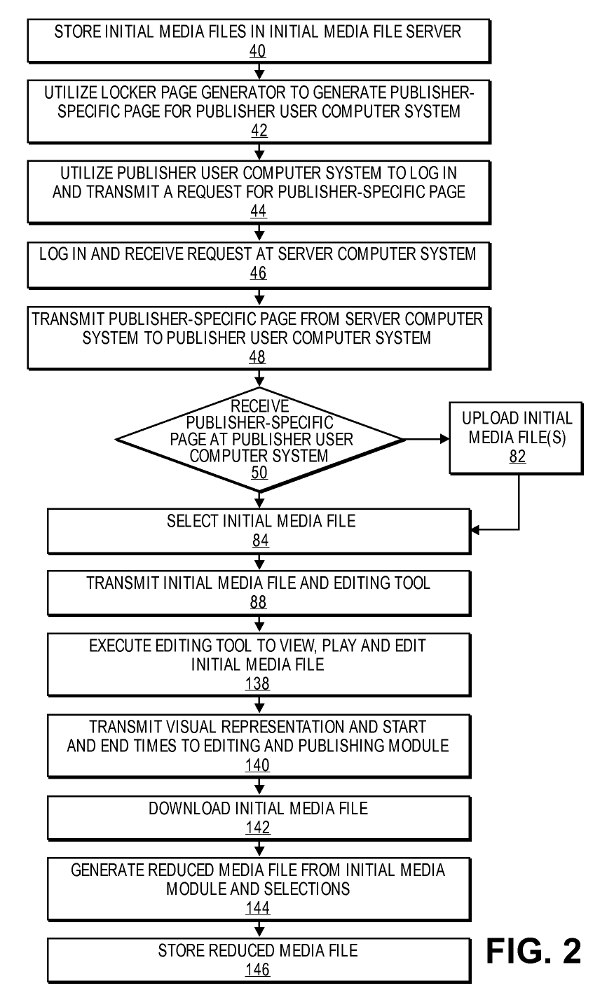

FIG. 2 illustrates how a reduced media file is created utilizing the network system 20 of FIG. 1. At step 40, initial media files are stored in the initial media file server 30. The initial media files are all time-based playable media files, such as audio or video files. For purposes of further discussion, the invention is described by way of example with respect to an audio music file such as a Moving Picture Experts Group (MPEG) 1 Audio Layer 3 (MP3) file having a length of three to four minutes and forming a complete track. Whether audio or video files are stored and used, the initial media file will have media content playing from a start time to an end time over a first duration of time.

At step 42, the publisher-specific page generator 32 generates the publisher-specific page 34 for the publisher user computer system 24A.

At step 44, a publisher user utilizes the publisher user computer system 24A to log into and to transmit a request for the publisher-specific page 34 over the internet 28. A signal that is transmitted from the publisher user computer system 24A includes an address for the server computer system 22, a request for the publisher-specific page 34, and a return address of the publisher user computer system 24A. At step 46, the server computer system 22 receives the log-in and the request for the publisher-specific page 34. The transmission and reception of the request for the publisher-specific page 34 completes one transaction between the publisher user computer system 24A and the server computer system 22 over the internet 28.

At step 48, the server computer system 22 transmits the publisher-specific page 34 from the server computer system 22 over the internet 28 to the publisher user computer system 24A. A signal that is transmitted from the server computer system 22 includes the publisher-specific page 34 and the return address of the publisher user computer system 24A. At step 50, the publisher user computer system 24A receives the publisher-specific page 34 over the internet 28 from the server computer system 22. The transmission and reception of the publisher-specific page 34 thus completes a second transaction between the publisher user computer system 24A and the server computer system 22.

The second transaction is automatically executed in response to the first transaction, and the first and second transactions complete one communication exchange between the publisher user computer system 24A and the server computer system 22. One complete communication exchange is thus described to differentiate over non-network-type systems. For purposes of expediency, not every transaction over the internet 26 or 28 or every communication exchange is described in detail herein, although it should be understood that such transactions or communication exchanges will follow a procedure similar to the one described above.

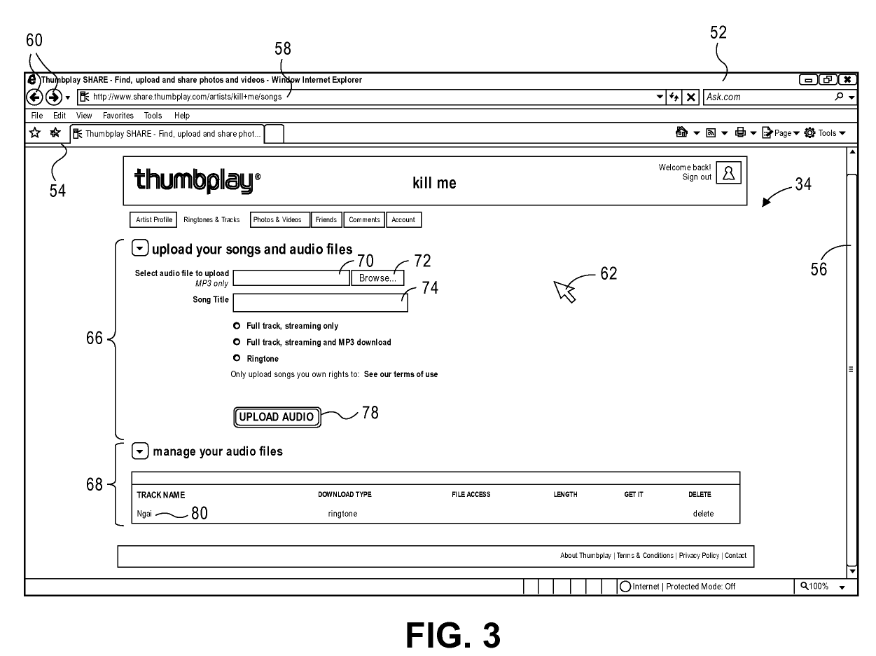

FIG. 3 illustrates a view of the publisher-specific page 34 within a browser view 52 at the publisher user computer system 24A in FIG. 1. The browser view 52 includes a viewing pane 54 within which the publisher-specific page 34 is displayed. The browser 52 also includes a vertical scroll bar 56 that can be moved up or down to view portions of the publisher-specific page 34 if the entire publisher-specific page 34 does not fit vertically within the viewing pane 54. The browser 52 also has an address box 58 and back and forward buttons 60. A user can use a mouse to move a cursor 62 into the address box 58, and then depress a button on the mouse to select the address box 58. The user can then utilize a keyboard to enter text such as “http://www.thumbplay.com” in the address box 58, and can then depress an “enter” key on the keyboard to transmit a signal and a request for a page. The text within the address box 58 can also be automatically updated; for example, when a user logs into the publisher-specific page 34. The back and forward buttons 60 can be used to view earlier or subsequent pages.

The publisher-specific page 34 includes an initial media file upload area 66 and an initial media file access area 68. The initial media file upload area 66 has a file directory field 70, a browse button 72, an initial media file title field 74, and an upload button 78. The initial media file access area 68 has one or more links 80 to initial media files.

Referring again to FIG. 2, initial media files may be associated with the publisher-specific page 34 and be represented by one or more of the links 80 in FIG. 3 at step 40. In addition, the publisher user computer system 24A in FIG. 1 can be used to upload further initial media files at step 82 in FIG. 2. In FIG. 3, the publisher user moves the cursor 62 over the browse button 72, and selects the browse button 72 to open a file directory on a hard drive of the publisher user computer system 24A. The publisher user then selects an initial media file in the file directory, and a file directory name then appears in the file directory field 70. The publisher user then types an initial media file title in the initial media file title field 74. The publisher user then selects the upload button 78, which causes transmission of a copy of the initial media file and the initial media file title from the publisher user computer system 24A over the internet 28 to the server computer system 22. The initial media file and its associated title are stored in the initial media file server 30. The publisher-specific page generator 32 then updates the publisher-specific page 34 with the uploaded initial media file and its title. A link 80 is added to the publisher-specific page 34, and includes the name of the initial media file title that is uploaded.

Referring again to FIG. 2, at step 84, the publisher user at the publisher user computer system 24A in FIG. 1 selects an initial media file by selecting one of the links 80 in the publisher-specific page 34 of FIG. 3. As shown in FIG. 1, the server computer system further includes an editing tool 86. In step 88 in FIG. 2, the editing tool 86 is transmitted together with the initial media file stored in the initial media file server 30 from the server computer system 22 over the internet 28 to the publisher user computer system 24A. Both the editing tool 86 and the initial media file are constantly streamed over the internet 28 to the publisher user computer system 24A.

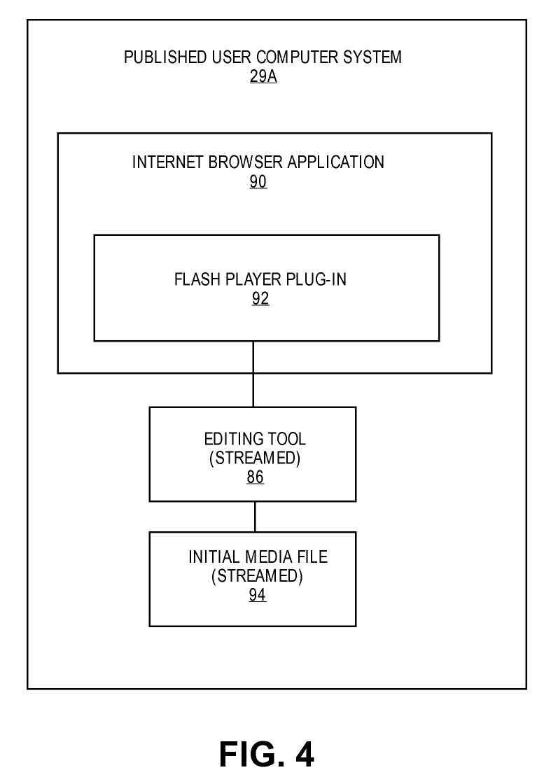

FIG. 4 illustrates software components that reside on the publisher user computer system 24A. An internet browser application 90 and a flash player plug-in 92 are pre-installed on the publisher user computer system 24A. The internet browser application 90 includes internet protocol for receiving and transmitting signals over the internet. The internet browser application 90 also includes the browser view 52 of FIG. 3, and displays downloaded data and web pages such as the publisher-specific page 34 in FIG. 3. The internet browser application 90 may, for example, be an internet Explorer®, Netscape®, or Firefox® internet browser application.

The flash player plug-in 92 is separately downloaded and installed on the publisher user computer system 24A. The flash player plug-in 92 enhances functionality of the internet browser application 90 by providing the ability to play downloaded files, and to provide for limited user interactivity to control the way that the downloaded files are played. The flash player plug-in 92 may, for example, be an Adobe® flash player.

The editing tool 86 that is streamed from the server computer system 22 in FIG. 1 is connected to the flash player plug-in 92. An initial media file 94 that is streamed from the initial media file server 30 in FIG. 1 is connected to the editing tool 86. The flash player plug-in 92 plays the editing tool 86. The editing tool 86, in turn, provides a sound output and a visual representation of sound levels of the initial media file, if the initial media file 94 is an audio track. In another example where the initial media file 94 includes video, the editing tool 86 also provides a video output of the initial media file 94.

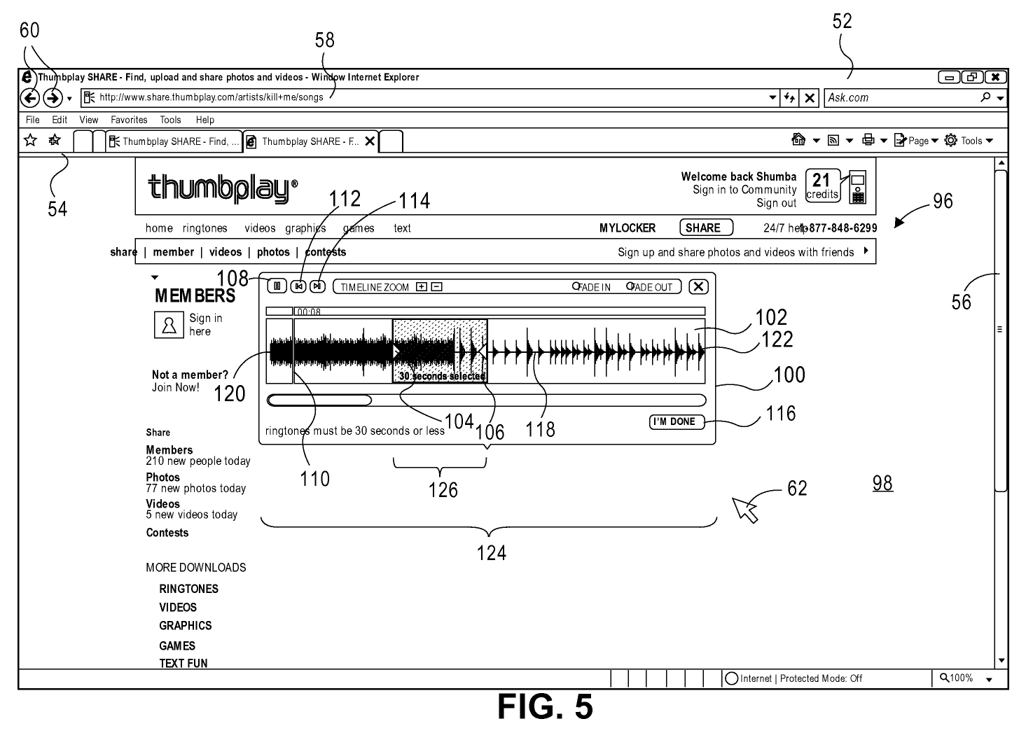

FIG. 5 shows a view 96 that is automatically displayed during streaming of the editing tool 86 and the initial media file 94 in FIG. 4. The view 96 includes an editing page 98 and an editing window 100 on the editing page 98. The editing window 100 forms part of the editing tool 86 in FIG. 1, and includes a visual representation area 102, start and end selection markers 104 and 106, a pause/play button 108, a playback position indicator 110, forward and backward skip buttons 112 and 114 respectively, and a “complete” button 116, labeled “I'm done.” A visual representation 118 of the initial media file 94 in FIG. 4 is displayed within the visual representation area 102. The visual representation of the initial media file 94 has a start time 120 on the left and an end time 122 on the right. The start and end selection markers 104 and 106 and the playback position indicator 110 are all located on the visual representation 118 between the start time 120 and the end time 122.

Selection of the pause/play button 108 causes movement of the playback position indicator 110 at a constant speed from left to right across the visual representation 118. The editing tool 86 also creates a sound output of the initial media file 94, so that the initial media file 94 plays back at a constant speed. The position of the playback indicator 110 on the visual representation 118 thus indicates the corresponding position during the audio playback. The cursor 62 can be positioned on the playback position indicator 110, and the button on the mouse can be held down to “grab” onto the playback position indicator 110. The position of the playback indicator 110 can then be moved together with the cursor to a new playback position anywhere to the left of the right on the visual representation 118. When the button on the mouse is released, playback will start at the new position. It is also possible to play the entire initial media file, i.e., from the start time 120 to the end time 122 over a first duration of time 124.

A difference in time between the start selection marker 104 and the end selection marker 106 represents a second duration of time 126. The second duration of time 126 is located within and is shorter than the first duration of time 124. Specifically, the start selection marker 104 is positioned after the start time 120, and the end selection marker 106 is located after the start selection marker 104, but before the end time 122.

The start and end selection markers 104 and 106 allow a publisher user to select a reduced media file corresponding to a section of the initial media file 94 in FIG. 1, with the reduced media file starting at the start selection marker 104 and ending at the end selection marker 106 with a maximum length of 30 seconds.

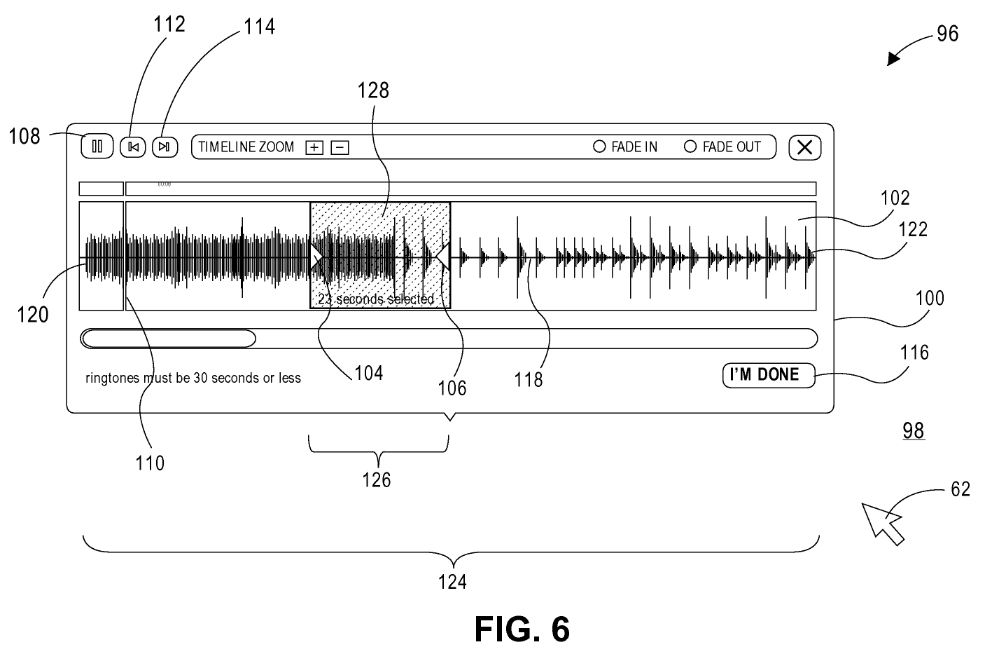

Referring to FIG. 6, the publisher user has positioned the cursor 62 on the start selection marker 104 of FIG. 5, and has moved the start selection marker 104 seven seconds to the right. The start selection marker 104 is moved in a manner similar to the way that the playback position indicator 110 can be moved. With the end selection marker 106 remaining in the same position in FIG. 6 as in FIG. 5, the second duration of time 126 is now 23 seconds.

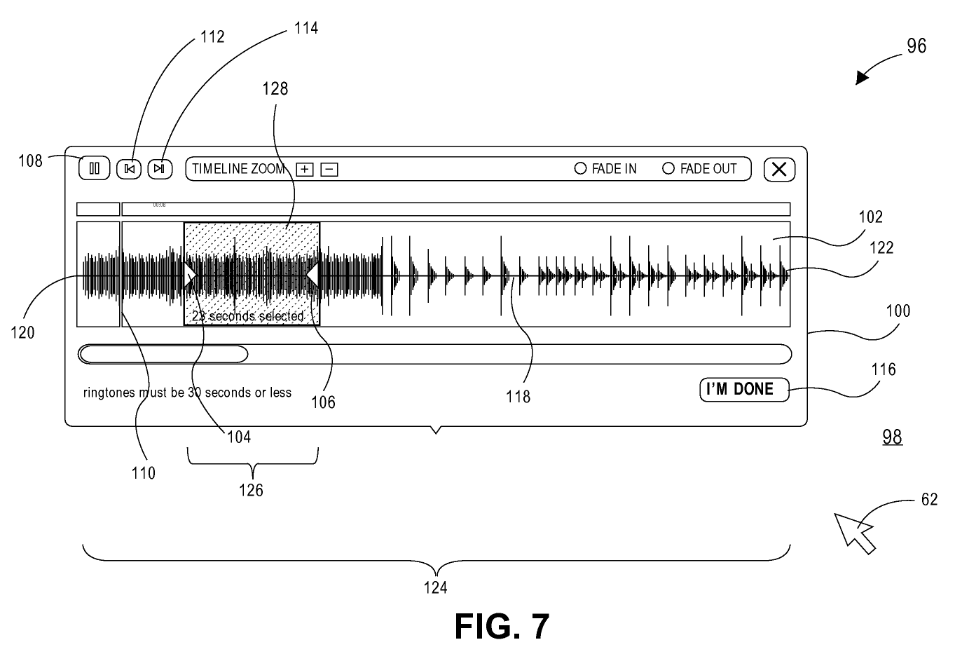

Referring to FIG. 7, the publisher user has “grabbed” onto an area 128 between the start and end selection markers 104 and 106 in FIG. 6, and has moved the cursor to the left. When moving the cursor to the left, the start and end selection markers 104 and 106 move to the left in unison with the cursor 62. The start and end selection markers 104 and 106 in FIG. 7 are thus positioned to the left of their respective positions shown in FIG. 6. The second duration of time 126 automatically remains at 23 seconds, as in FIG. 6.

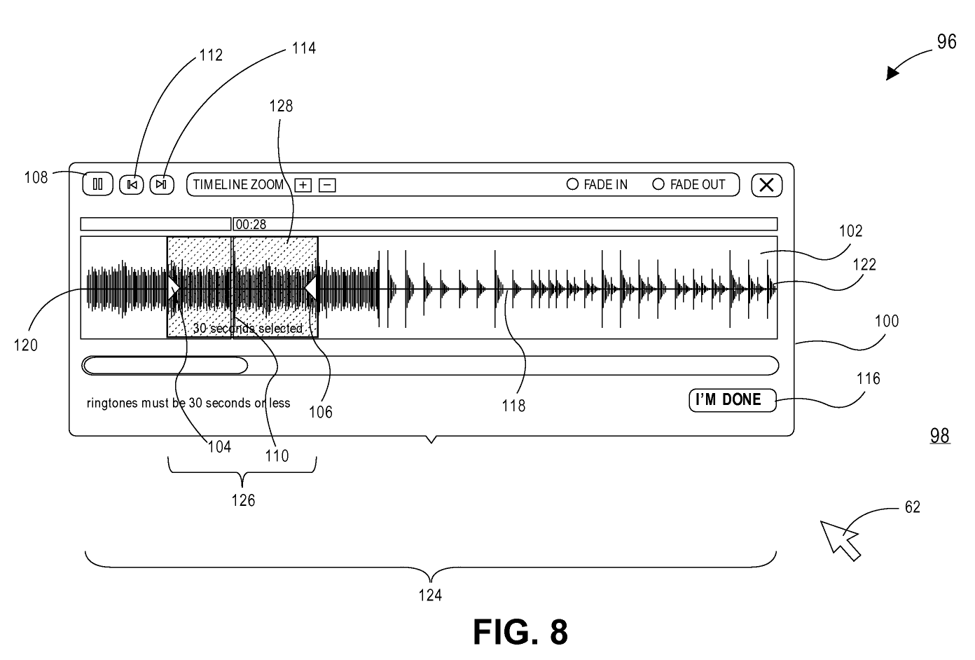

Referring to FIG. 8, the publisher user has selected the end selector marker 106 in FIG. 7, and has moved the end selection marker 106 to the right in FIG. 8 compared to its position in FIG. 7. The end selection marker 106 continues to move to the right until the second duration of time 126 is 30 seconds. The editing tool 86 in FIG. 4, however, limits the maximum duration of the second duration 126 to 30 seconds.

Following the positioning of the start and end selection markers 104 and 106 at desired locations on the visual representation 118, the publisher user may listen to a section of the initial media file 94 between the start and end selection markers 104 and 106 by sliding the playback position indicator 110 to the start selection marker 104, and then selecting the pause/play button 108, if necessary. The playback position indicator 110 then progresses through the area 128, and an audio output is created, corresponding to the position of the playback position indicator 110 within the area 128. The publisher user can then make any further adjustments to the start and end selection markers 104 and 106, if necessary, and again listen to the selected section. Following final selection of the section of the initial media file 94, the publisher user positions the cursor 62 on and selects the “complete” button 116.

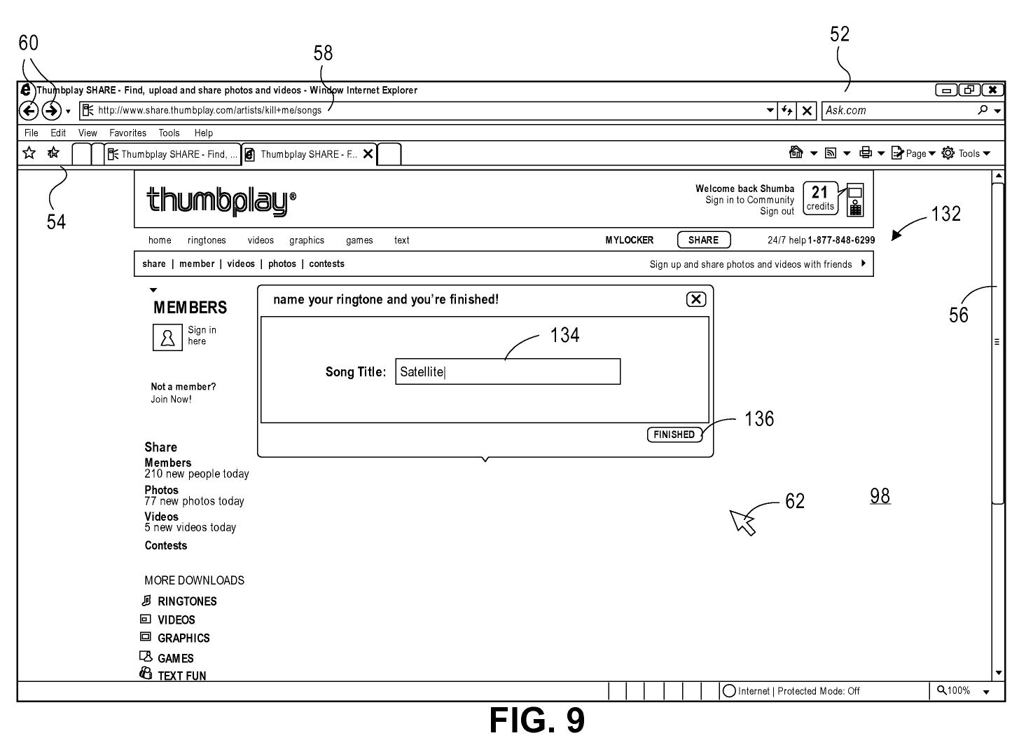

FIG. 9 illustrates a view 132 that automatically displays within the browser view 52 upon selection of the “complete” button 116 in FIG. 8. The view 132 includes a reduced media file title field 134 where a name for the reduced media file is entered, utilizing the keyboard. The publisher user then selects a “finished” button 136.

Referring again to FIG. 2, step 138 has been completed, wherein the editing tool 86 in FIG. 4 is executed to view the visual representation 118 in FIG. 5, and the initial media file is editing as described with reference to FIGS. 5 to 8.

At step 140, the visual representation 118 and start and end times selected using the start and end selection markers 104 and 106 in FIG. 8 are transmitted from the publisher user computer system 24A in FIG. 1 over the internet 26 to the editing and publishing module 36. Such transmission also serves as a publish command and a reduction command. A tag that identifies the initial media file 94 in the initial media file server 30 in FIG. 1 and the name entered in the reduced media file title field 134 in FIG. 9 are also transmitted from the publisher user computer system 24A in FIG. 1 over the internet 26 to the editing and publishing module 36. At step 142, the editing and publishing module 36 utilizes the tag to download the initial media file 94 from the initial media file server 30. At step 144, the editing and publishing module 36 generates or creates a reduced media file. The reduced media file includes only the section of the initial media file 94 from the start to the end selection markers 104 and 106 in FIG. 8. The editing and publishing module 36 then stores the reduced media file in the reduced media file server 38.

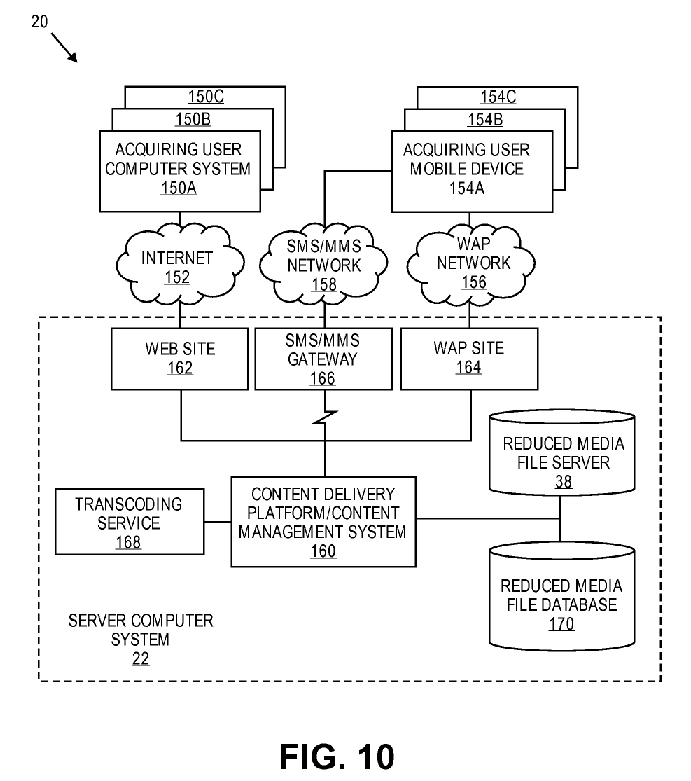

FIG. 10 illustrates another part of the network system 20 of FIG. 1, including a plurality of acquiring user computer systems 150A, B, and C that are connected over the internet 152 to the server computer system 22, a plurality of acquiring user mobile devices 154A, B, and C that are connected over a Wide Application Protocol (WAP) network 156 and, a Short Message Service (SMS) and Multimedia Messaging Service (MMS) network 158 to the server computer system 22.

The server computer system 22, in addition to the reduced media file server 38, further includes a content delivery platform and content management system 160, a website 162, a WAP site 164, an SMS/MMS gateway 166, a transcoding service 168, and a reduced media file database 170. The reduced media file database 170 is connected to the reduced media file server 38. The content delivery platform and content management system 160 forms the center of the server computer system 22 and all the other components, including the web site 162, WAP site 164, SMS/MMS gateway 166, transcoding service 168, reduced media file server 38 and reduced media file database 170 are directly connected to the content delivery platform and content management system 160. The content delivery platform and content management system 160 indexes files from the reduced media file server 38 into the reduced media file database 170 in a structured manner as required for downloading and for the website 162, WAP site 164, SMS/MMS gateway 166, and transcoding service 168. The transcoding service 168 utilizes the contents of the reduced media file database 170 to generate web pages for the web site 162. In a similar manner, the transcoding service 168 creates pages for the WAP site 164 and the contents of SMS/MMS messages that are transmitted to the SMS/MMS gateway 166.

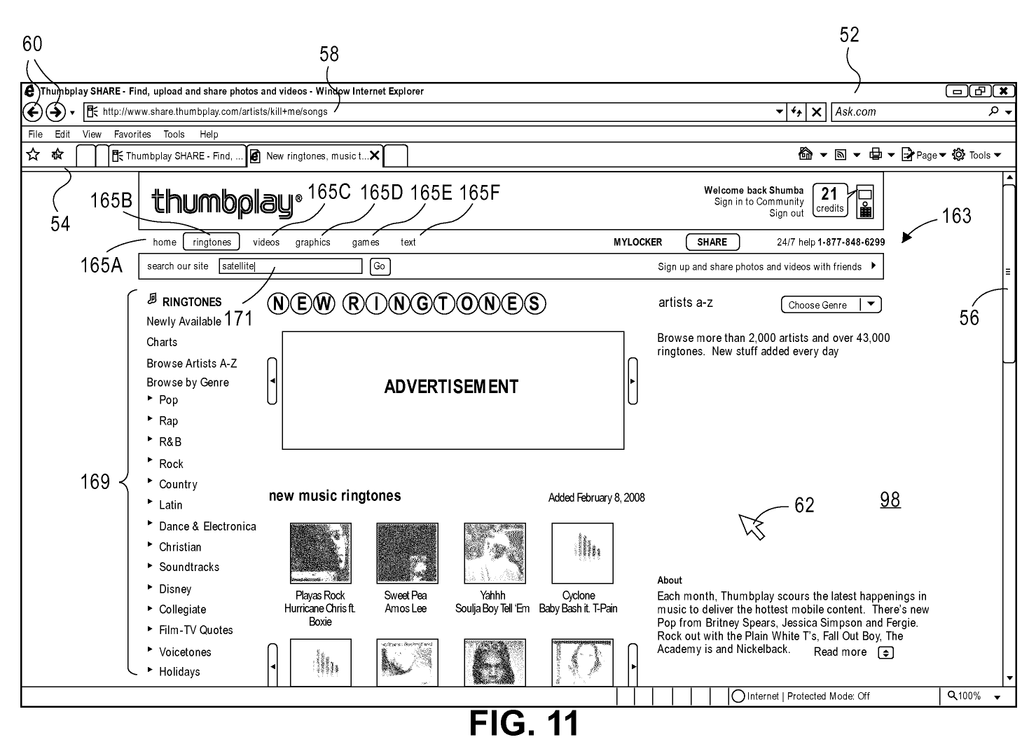

FIG. 11 shows a view 163 that is in a general area of the website 162 in FIG. 10. The view 163 includes tabs 165A to F that provide links to other pages of the general area. In the view 163, the tab 165B is highlighted, indicating that the view 163 is in a portion of the general area relating to ringtones.

The view 163 is typically displayed at one of the acquiring user computer systems 150A, B, or C in FIG. 10, and provides the acquiring user computer system 150A, B, or C access to ringtones through a browse menu 169 or by entering text in a search box 171. Text can, for example, be entered in the search box 171, and an acquiring user can then either select a “go” button 172 or hit “enter” on a keyboard to cause transmission of a signal from the acquiring user computer system 150A, B, or C over the internet 152 to the website 168. The signal includes an address for the website 168, a query that is entered in the search box 171, and a return address for the acquiring user computer system 150A, B, or C. The query is used at the website 168 to extract one or more search results. A signal is then transmitted from the website 168 over the internet 152 to the acquiring user computer system 150A, B, or C, the signal including the search result or search results and an address corresponding to the return address received from the acquiring user computer 150A, B, and C.

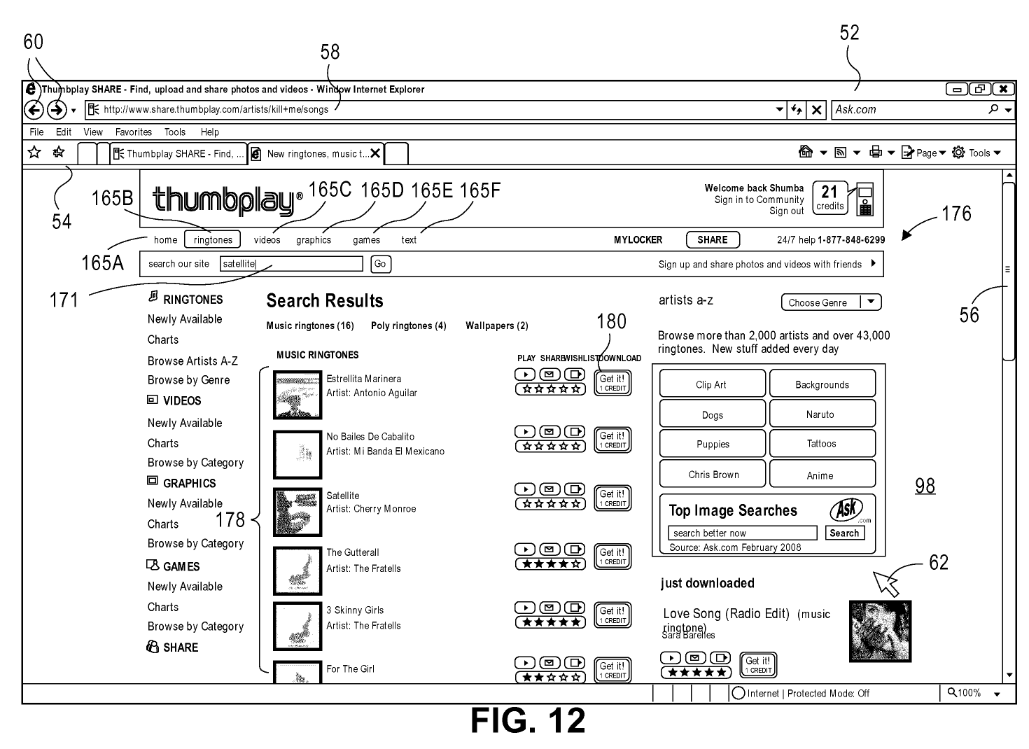

FIG. 12 shows a view 176 that includes a page with a plurality of search results 178 that are received at the acquiring user computer system 150A, B, or C over the internet 152 from the website 162. In the present example, the text or query entered in the search box 171 in the view 163 of FIG. 11 corresponds to the name that was entered in the reduced media file title field 134 in the view 132 of FIG. 9, and the same name is returned as one of the search results 178. Each search result 178 includes a ringtone name, an artist name, and a “download” button 180, among other things.

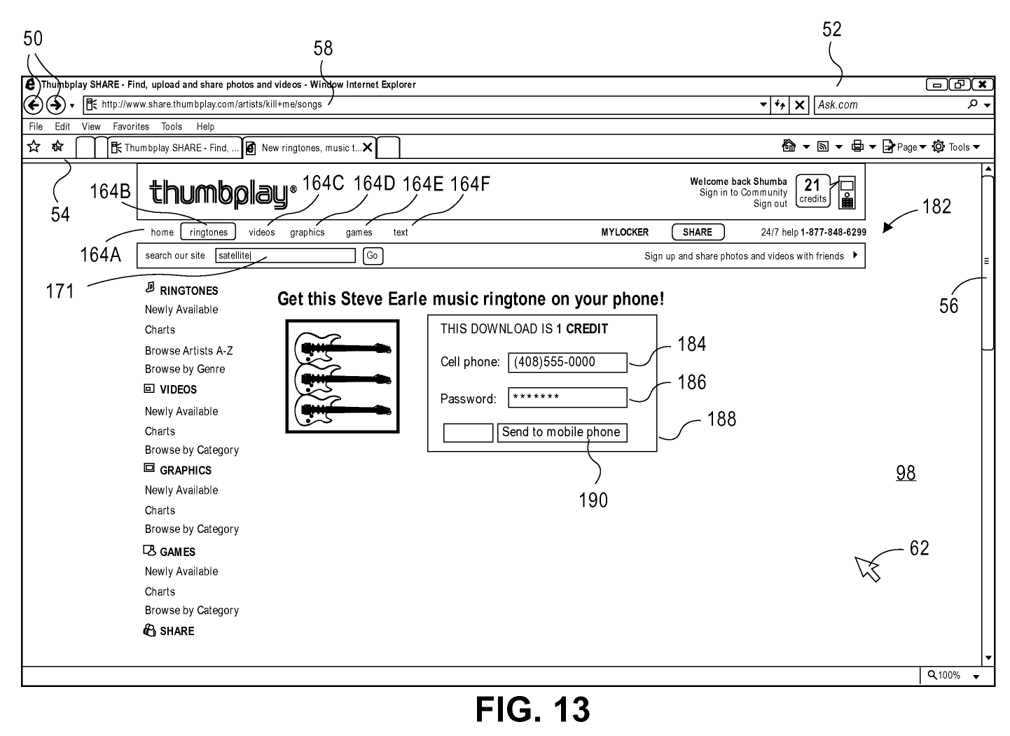

FIG. 13 shows a view 182 that is displayed upon selection of one of the “download” buttons 180 in the view 176 of FIG. 12. A profile of the acquiring user computer system 150A is previously stored on the content management system and content delivery platform 160 of FIG. 10, including a mobile phone number 184 and a password 186. The view 182 includes the mobile phone number 184 and a password text box 188 for entering the password 186. The view 182 also has a “transmission” button 190. Upon selection of the “transmission” button 190, a signal is sent from the acquiring user computer system 150A over the internet 152 to the website 162. The website 162 communicates with the content management system and content delivery platform 160, which uses the selected search result to access one of the ringtones on the reduced media file server 38. The content management system and content delivery platform 160 then transmits a link corresponding to the accessed ringtone on the reduced media file server 38 over the SMS/MMS networks 158 to an acquiring user mobile device 154A, B, or C having the mobile phone number 184 in the view 182 of FIG. 13.

The link that is received at the acquiring user mobile device 154A, B, or C comes in the form of a simple SMS message that includes the link. An acquiring user can utilize “arrow” and “enter” keys of the acquiring user mobile device 154A, B, or C to select the link. Upon selection of the link, the acquiring user mobile device 154A, B, or C transmits a requesting signal over the WAP network 156 to the content management system and content delivery platform 160, which then automatically transmits a copy of the selected ringtone from the reduced media file server 38 over the WAP network 156 to the respective acquiring user mobile device 154A, B, or C. The respective acquiring user mobile device 154A, B, or C then automatically stores the copy of the selected ringtone in memory.

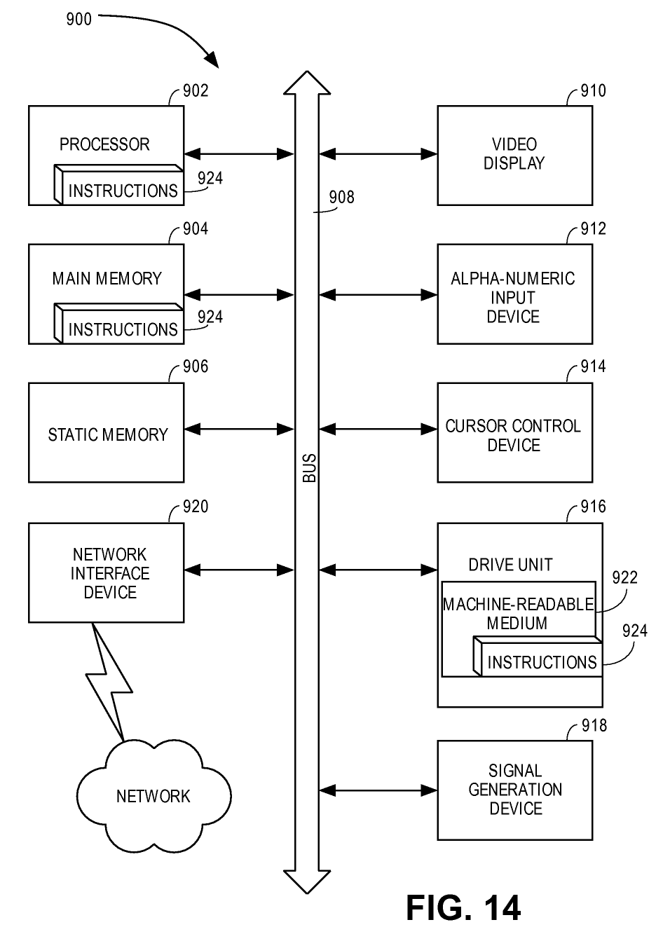

FIG. 14 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 902 (e.g., a central processing unit (CPU), a graphics processing unit (GPU) or both), a main memory 904 (e.g., read only memory (ROM), flash memory, dynamic random access memory (DRAM) such as synchronous DRAM (SDRAM) or Rambus DRAM (RDRAM), etc.), and a static memory 906 (e.g., flash memory, static random access memory (SRAM), etc.), which communicate with each other via a bus 908.

The computer system 900 may further include a video display 910 (e.g., a liquid crystal display (LCD) or a cathode ray tube (CRT)). The computer system 900 also includes an alpha-numeric input device 912 (e.g., a keyboard), a cursor control device 914 (e.g., a mouse), a disk drive unit 916, a signal generation device 918 (e.g., a speaker), and a network interface device 920.

The disk drive unit 916 includes a machine-readable medium 922 on which is stored one or more sets of instructions 924 (e.g., software) embodying any one or more of the methodologies or functions described herein. The software may also reside, completely or at least partially, within the main memory 904 and/or within the processor 902 during execution thereof by the computer system 900, the main memory 904 and the processor 902 also constituting machine-readable media.

The software may further be transmitted or received over a network 928 via the network interface device 920.

While the machine-readable medium 924 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A computer-based method of manipulating electronic media, comprising:
transmitting an initial media file to a publishing user computer system, the initial media file having media content playing from a start time to an end time over a first duration of time;
transmitting an editing tool to the publishing user computer system, the editing tool being usable at the publishing user computer system to make at least one time selection after the start time and before the end time of the initial media file;
receiving a publish command from the publishing user computer system at a server computer system; and
storing a reduced media file at the server computer system in response to the publish command, the reduced media file having media content from the initial media file, playing over a second duration of time that is shorter than the first duration of time, and having at least one of a start time and an end time that depends on the time selection made using the editing tool at the publishing user computer system.

2. The method of claim 1, further comprising:
receiving at least one reduction command from the publishing user computer system at the server computer system, the reduction command including the time selection and the reduced media file being extracted from the initial media file at the server computer system in response to the server computer system receiving the reduction command and utilizing the time selection.

3. The method of claim 1, wherein the time selection is a start time selection, the editing tool further being usable to make an end time selection after the start time selection and before the end time of the initial media file, the reduced media file having a start time depending on the start time selection and an end time depending on the end time selection.

4. The method of claim 3, wherein the second duration has a maximum duration that is limited other than by the starting time and the end time of the initial media file.

5. The method of claim 4, wherein the second duration can be less than the maximum duration.

6. The method of claim 4, wherein adjustment of one of the time selections automatically adjusts the other time selection.

7. The method of claim 6, wherein adjustment of one of the time selections automatically adjusts the other time selection when the second duration is less than the maximum duration.

8. The method of clam 1, wherein the editing tool creates a sound output of the media content of the initial media file.

9. The method of claim 2, wherein the editing tool creates a visual representation on a display of the publishing user computer system, the visual representation including time for purposes of making the time selection.

10. The method of claim 1, further comprising:
transmitting at least one naming field to the publishing user computer system, a name being entered in the naming field at the publishing user computer system being saved and related to the reduced media file at the server computer system.

11. The method of claim 1, further comprising:
publishing a link to the reduced media file on a web page;
receiving a download selection command from an acquiring user computer system upon selection of the link; and
in response to the download selection command, transmitting the reduced media file from the server computer system.

12. The method of claim 1, wherein the reduced media file is transmitted to an acquiring user mobile phone.

13. A computer-readable medium, having stored thereon a set of instructions that, when executed by a processor of a computer, carries out a computer-based method of manipulating electronic media, comprising:
transmitting an initial media file to a publishing user computer system, the initial media file having media content playing from a start time to an end time over a first duration of time;
transmitting an editing tool to the publishing user computer system, the editing tool being usable at the publishing user computer system to make at least one time selection after the start time and before the end time of the initial media file;
receiving a publish command from the publishing user computer system at a server computer system; and
storing a reduced media file at the server computer system in response to the publish command, the reduced media file having media content from the initial media file, playing over a second duration of time that is shorter than the first duration of time, and having at least one of a start time and an end time that depends on the time selection made using the editing tool at the publishing user computer system.

14. A server computer system for manipulating electronic media, comprising:
at least one file database from which an initial media file is transmitted to a publishing user computer system, the initial media file having media content playing from a start time to an end time over a first duration of time;
an editing tool that is transmitted to the publishing user computer system, the editing tool being usable at the publishing user computer system to make at least one time selection after the start time and before the end time of the initial media file;
a publishing component receiving a publish command from the publisher user computer system and storing a reduced media file in response to the publish command, the reduced media file having media content from the initial media file, playing over a second duration of time that is shorter than the first duration of time, and having at least one of a start time and an end time that depends on the time selection made using the editing tool at the publishing user computer system.
